(19) United States
(12) Patent Application Publication
(10) Pub. No.: US 2024/0421865 A1
(43) Pub. Date: Dec. 19, 2024

(54) MACHINE LEARNING MODELS FOR PRECODING

(71) Applicant: QUALCOMM INCORPORATED, San Diego, CA (US)

(72) Inventors: Qiaoyu Li, Beijing (CN); Mahmoud Taherzadeh Boroujeni, San Diego, CA (US); Tao Luo, San Diego, CA (US)

(21) Appl. No.: 18/698,531

(22) PCT Filed: Dec. 1, 2021
(86) PCT No.: PCT/CN2021/134751

§ 371 Date: Apr. 4, 2024

(51) Int. Cl. H04B 7/0456; H04W 24/02; H04W 72/044

(52) U.S. Cl. CPC H04B 7/0456; H04W 24/02; H04W 72/044

(57) ABSTRACT

Methods, systems, and devices for wireless communication at a user equipment (UE) are described. A user equipment (UE) may receive a control message from a base station indicating a machine learning model for generating or compressing one or more components of a precoding matrix indicator. The UE may determine or compress the one or more components of the precoding matrix indicator in accordance with the machine learning model and based on a characteristic of a wireless channel. The UE may transmit a precoding matrix indicator message including the one or more components of the precoding matrix indicator that are determined or compressed in accordance with the machine learning model.

### CROSS REFERENCE

The present application is a 371 national stage filing of International PCT Application No. PCT/CN2021/134751 by Li et al. entitled “MACHINE LEARNING MODELS FOR PRECODING,” filed Dec. 1, 2021, which is assigned to the assignee hereof, and which is expressly incorporated by reference in its entirety herein.

### FIELD OF TECHNOLOGY

The following relates to wireless communication at a user equipment (UE), including machine learning models for precoding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In the course of wireless communications, a user equipment (UE) may transmit one or more precoding matrix indicators (PMIs) to the base station to indicate a precoder requested by the UE for use in beamforming communications to the UE.

### SUMMARY

The described techniques relate to improved methods, systems, devices, and apparatuses that support machine learning models for precoding. Generally, the described techniques provide for determination or compression of precoding matrix indicator components based on a received machine learning model. For example, a user equipment (UE) may receive a control message from a base station indicating a machine learning model for generating or compressing one or more components of a precoding matrix indicator. The UE may determine or compress the one or more components of the precoding matrix indicator in accordance with the machine learning model and based on a characteristic of a wireless channel. The UE may transmit a precoding matrix indicator message including the one or more components of the precoding matrix indicator that are determined or compressed in accordance with the machine learning model.

A method for wireless communication at a user equipment (UE) is described. The method may include receiving a control message from a base station indicating a machine learning model for generating or compressing one or more components of a precoding matrix indicator, determining or compressing the one or more components of the precoding matrix indicator in accordance with the machine learning model and based on a characteristic of a wireless channel, and transmitting a precoding matrix indicator message including the one or more components of the precoding matrix indicator that are determined or compressed in accordance with the machine learning model.

An apparatus for wireless communication at a UE is described. The apparatus may include a processor, memory coupled with the processor, and instructions stored in the memory. The instructions may be executable by the processor to cause the apparatus to receive a control message from a base station indicating a machine learning model for generating or compressing one or more components of a precoding matrix indicator, determine or compress the one or more components of the precoding matrix indicator in accordance with the machine learning model and based on a characteristic of a wireless channel, and transmit a precoding matrix indicator message including the one or more components of the precoding matrix indicator that are determined or compressed in accordance with the machine learning model.

Another apparatus for wireless communication at a UE is described. The apparatus may include means for receiving a control message from a base station indicating a machine learning model for generating or compressing one or more components of a precoding matrix indicator, means for determining or compressing the one or more components of the precoding matrix indicator in accordance with the machine learning model and based on a characteristic of a wireless channel, and means for transmitting a precoding matrix indicator message including the one or more components of the precoding matrix indicator that are determined or compressed in accordance with the machine learning model.

A non-transitory computer-readable medium storing code for wireless communication at a UE is described. The code may include instructions executable by a processor to receive a control message from a base station indicating a machine learning model for generating or compressing one or more components of a precoding matrix indicator, determine or compress the one or more components of the precoding matrix indicator in accordance with the machine learning model and based on a characteristic of a wireless channel, and transmit a precoding matrix indicator message including the one or more components of the precoding matrix indicator that are determined or compressed in accordance with the machine learning model.

In some examples of the method, apparatuses, and non-transitory computer-readable medium described herein, the machine learning model includes a neural network based model and the method, apparatuses, and non-transitory computer-readable medium may include further operations, features, means, or instructions for receiving a downlink control information from the base station indicating a change in neural network parameters for the machine learning model, where determining or compressing the one or more components of the precoding matrix indicator may be in accordance with the change in neural network parameters.

Some examples of the method, apparatuses, and non-transitory computer-readable medium described herein may further include operations, features, means, or instructions for applying the change in neural network parameters according to a timing defined by one or more of: a downlink data transmission scheduled by the downlink control information, an acknowledgment of the downlink control information, an uplink control transmission scheduled by the downlink control information, a configuration message from the base station, or any combination thereof.

In some examples of the method, apparatuses, and non-transitory computer-readable medium described herein, the machine learning model includes a kernel based model.

Some examples of the method, apparatuses, and non-transitory computer-readable medium described herein may further include operations, features, means, or instructions for determining or compressing the one or more components of the precoding matrix indicator may be further based on a transmission rank associated with the UE, a transmission layer associated with the UE, a transmission polarization associated with the UE, or any combination thereof.

In some examples of the method, apparatuses, and non-transitory computer-readable medium described herein, an output size of compressing the one or more components of the precoding matrix indicator may be based on a transmission rank associated with the UE, a transmission layer associated with the UE, a transmission polarization associated with the UE, or any combination thereof.

Some examples of the method, apparatuses, and non-transitory computer-readable medium described herein may further include operations, features, means, or instructions for receiving from the base station an indication of a numerical quantity of spatial domain bases or frequency domain bases associated with the precoding matrix indicator.

In some examples of the method, apparatuses, and non-transitory computer-readable medium described herein, an output size of compressing the one or more components of the precoding matrix indicator may be based on the numerical quantity of spatial domain bases or frequency domain bases.

Some examples of the method, apparatuses, and non-transitory computer-readable medium described herein may further include operations, features, means, or instructions for receiving, from the base station, an output size of compressing the one or more components of the precoding matrix indicator.

Some examples of the method, apparatuses, and non-transitory computer-readable medium described herein may further include operations, features, means, or instructions for transmitting the precoding matrix indicator message includes packing the compressed one or more components of the precoding matrix indicator into a first portion of a channel state information, where the output size may be independent of a rank indicator or a numerical quantity of the compressed one or more components of the precoding matrix indicator.

Some examples of the method, apparatuses, and non-transitory computer-readable medium described herein may further include operations, features, means, or instructions for transmitting the precoding matrix indicator message includes packing the compressed one or more components of the precoding matrix indicator into a second portion of a channel state information, where the output size may be based on a rank indicator reported in a first portion of the channel state information.

Some examples of the method, apparatuses, and non-transitory computer-readable medium described herein may further include operations, features, means, or instructions for transmitting the precoding matrix indicator message includes transmitting a first portion of a channel state information including an output size of compressing the one or more components of the precoding matrix indicator and transmitting a second portion of the channel state information including the compressed one or more components of the precoding matrix indicator.

Some examples of the method, apparatuses, and non-transitory computer-readable medium described herein may further include operations, features, means, or instructions for receiving from the base station an indication of decoder information associated with the base station, where determining or compressing the one or more components of the precoding matrix indicator may be further based on the decoder information associated with the base station.

In some examples of the method, apparatuses, and non-transitory computer-readable medium described herein, an input to the machine learning model includes a channel state information reference signal, an indication of an estimated channel, an indication of interference on the estimated channel, one or more previously-determined precoding matrix indicator components, one or more previously-compressed precoding matrix indicator components, or any combination thereof.

In some examples of the method, apparatuses, and non-transitory computer-readable medium described herein, an output of the machine learning model includes an indication of a quantity of spatial domain bases, an indication of a selection of spatial domain bases, an indication of one or more frequency domain base types, a frequency domain base oversampling rate, a number of transfer domain bases, an indication of a selection of frequency domain bases, an indication of a quantity of one or more frequency domain base coefficients, an indication of one or more locations of a quantity of frequency domain base coefficients, one or more indications associated with a channel state information report, or any combination thereof.

### BRIEF DESCRIPTION OF THE DRAWINGS

FIG. 1 illustrates an example of a wireless communications system that supports machine learning models for precoding in accordance with examples as disclosed herein.

FIG. 2 illustrates an example of a wireless communications system that supports machine learning models for precoding in accordance with examples as disclosed herein.

FIG. 3 illustrates an example of a precoding matrix indicator processing scheme that supports machine learning models for precoding in accordance with examples as disclosed herein.

FIG. 4 illustrates an example of a precoding matrix indicator packing scheme that supports machine learning models for precoding in accordance with examples as disclosed herein.

FIG. 5 illustrates an example of a process flow that supports machine learning models for precoding in accordance with examples as disclosed herein.

FIGS. 6 and 7 show block diagrams of devices that support machine learning models for precoding in accordance with examples as disclosed herein.

FIG. 8 shows a block diagram of a communications manager that supports machine learning models for precoding in accordance with examples as disclosed herein.

FIG. 9 shows a diagram of a system including a device that supports machine learning models for precoding in accordance with examples as disclosed herein.

FIGS. 10 through 13 show flowcharts illustrating methods that support machine learning models for precoding in accordance with examples as disclosed herein.

### DETAILED DESCRIPTION

In the course of wireless communications, a user equipment (UE) may employ one or more precoding matrix indicators (PMIs) to indicate one or more precoders to a base station. The base station may determine, select, calculate, or otherwise obtain one or more precoders to be used in the course of downlink transmissions, and may do so based on the PMIs transmitted by the base station. Such determination, selection, calculation, or obtaining of precoders may further be done based on preconfigured parameters (e.g., radio resource control (RRC) preconfigured parameters), which may be numerous. However, the use of such preconfigured parameters may result in less robust or flexible communications schemes (e.g., in dynamic scenarios, such as scenarios involving high doppler spreads).

To improve robustness and flexibility, among other benefits, a wireless communications system may employ the use of one or more machine learning models (e.g., neural networks, kernel-based machine learning models, other machine learning models, or any combination thereof) to replace or augment existing approaches to precoder determination or selection. In some examples, a base station may preconfigure one or more options or parameters (e.g., neurons, structures, coefficients, other parameters, or any combination thereof) for the one or more machine learning models and may dynamically modify such options or parameters (e.g., through control signaling, such as downlink control information (DCI) or other control signaling). For example, a UE may receive control signaling from a base station indicating a machine learning model. The UE may determine, select, calculate, or compress one or more components of a PMI in accordance with the machine learning model and may further transmit the PMI to the base station. In some examples, the UE may transmit the PMI packaged within channel state information (CSI). In this way, the wireless communications system may be more robust and flexible in various conditions.

Aspects of the disclosure are initially described in the context of wireless communications systems. Aspects of the disclosure are then described in the context of a wireless communications system, a precoding matrix indicator processing scheme, a precoding matrix indicator packing scheme, and a process flow. Aspects of the disclosure are further illustrated by and described with reference to apparatus diagrams, system diagrams, and flowcharts that relate to machine learning models for precoding.

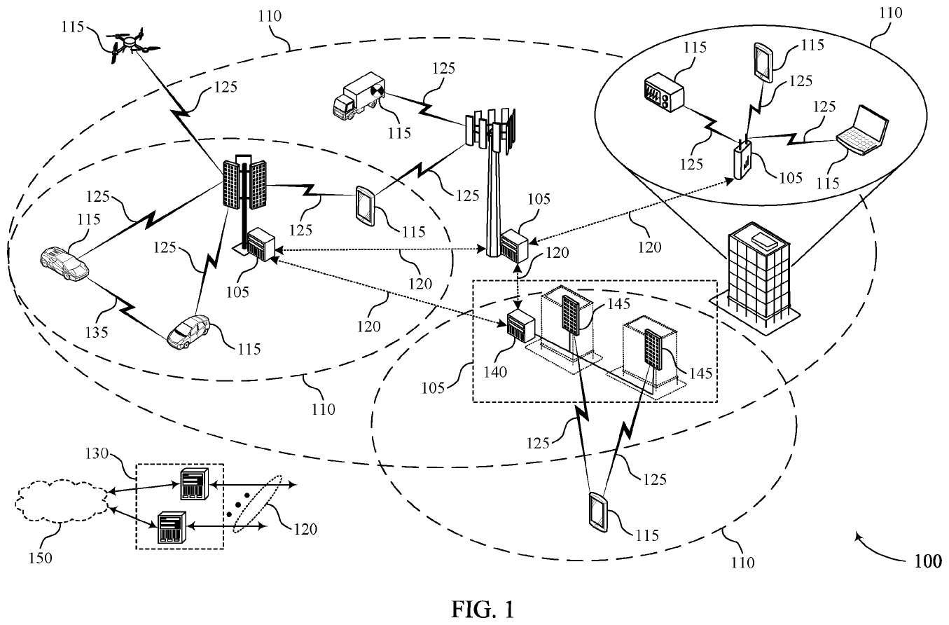

FIG. 1 illustrates an example of a wireless communications system 100 that supports machine learning models for precoding in accordance with examples as disclosed herein. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The UE 115 may receive one or more control messages from the base station 105 (e.g., downlink control information (DCI), RRC signaling, or other control messaging) that may indicate one or more machine learning models for generating PMI components, compressing PMI components, or both. The UE 115 may use the one or more machine learning models (e.g., process with a machine learning model or in accordance with such a model) to determine one or more PMI components, compress one or more PMI components, or both. For example, the UE 115 may determine one or more parameters or component associated with one or more PMIs (e.g., using one or more inputs, such as a CSI-RS or information associated therewith). Further, the UE 115 may compress one or more PMI components (e.g., components that were indicated by the base station 105, determined using a machine learning model, determined using one or more other approaches, or any combination thereof). Further, the UE 115 may transmit a PMI message (e.g., indicating one or more PMIs) that may include one or more PMI components (e.g., PMI components determined by the machine learning model or by other approaches, compressed by the machine learning model or other approaches, or any combination thereof). In this way, the UE 115 may reduce the complexity of PMI determination and reporting (e.g., by relying less on previously defined parameters, such as RRC parameters), provide more accurate PMI information, and increase communications capability and quality.

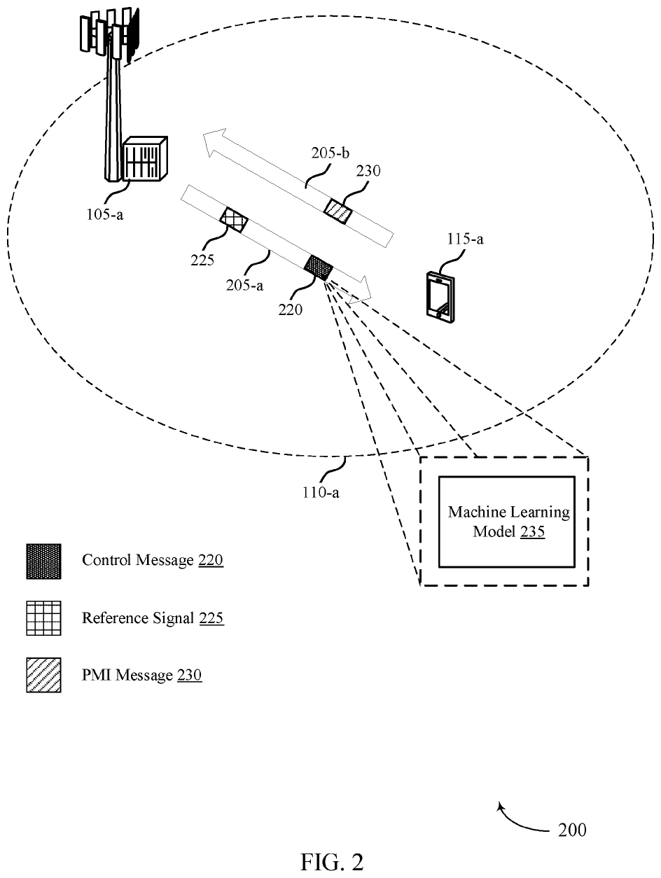

FIG. 2 illustrates an example of a wireless communications system 200 that supports machine learning models for precoding in accordance with examples as disclosed herein. The wireless communications system 200 may include a base station 105-a that may be an example of the base station 105 discussed in relation to FIG. 1. The wireless communications system 200 may include UE 115-a that may be an example of UE 115 discussed in relation to FIG. 1. In some examples, the base station 105-a and the UE 115 a may be located in a geographic coverage area 110-a. The base station 105-a and UE 115-a may communicate via one or more downlink communication links 205-a and one or more uplink communication links 205-b.

Wireless devices may calculate one or more precoders on one or more sub-bands used for PMI (e.g., as a linear combination of spatial beams). Further a wireless device may further aggregate one or more PMI coefficients (e.g., linear coefficients in a frequency domain). Some approaches may further include compression approaches, such as frequency domain compression of one or more PMI coefficients (e.g., via a discrete Fourier transform (DFT) basis). Such approaches may include transfer domain (e.g., delay domain) compression of the frequency domain linear combination coefficients (e.g., via a DFT basis). Such coefficients may be sparse in such a delay domain. In some such approaches, the wireless device may therefore report spatial beams, delay domain coefficients, compression DFT bases, or any combination thereof. Such approaches may offer improvements, such as reduced numbers of coefficients used (e.g., in a delay domain), finer quantization, higher rant, finer PMI granularity, increased performance, lower overhead, or any combination thereof.

One or more wireless devices may further employ the use of a codebook for PMI processing and transmission. For example, a wireless device may determine, identify, selected, or otherwise obtain precoders for one or more layers across one or more PMI sub-bands. Such precoders may be selected, measured, determined, computed, or otherwise obtained based on various factors. Such factors may include a (layer common) set of one or more spatial domain bases (e.g., DFT bases) in which a wireless device selects one or more beams, and the quantity of beams selected may be configured via control signaling (e.g., RRC signaling). Additional factors may include a (layer-specific) set of one or more frequency domain bases (e.g., DFT bases) that may be rank-pair specific (e.g., one or more bases may be paired based on a rank), and one or more frequency domain basis parameters may be configured via control signaling (e.g., RRC signaling). Additional factors may further include a (layer-specific) set of one or more coefficients. For each layer, a wireless device may report a quantity of coefficients (e.g., non-zero coefficients), and the quantity of coefficients may be defined via control signaling (e.g., RRC signaling). Additionally or alternatively, a wireless device may report, across all layers, a quantity of coefficients that is two times the quantity indicated via control signaling (e.g., RRC signaling).

Wireless devices may partition uplink control information (UCI) to indicate one or more factors, parameters, or values associated with PMI or other elements of a wireless communications scheme. In some examples, UCI may be divided into a first part and a second part. In some examples, the first part may include indications of one or more rank indicators, channel quality information, one or more coefficients (e.g., non-zero coefficients), or any combination thereof. In some examples, the second part may include indications of one or more spatial domain beam selections, one or more frequency domain basis selections, one or more strongest coefficients, one or more coefficient selections, quantization of one or more coefficients (e.g., non-zero coefficients), or any combination thereof.

Wireless devices may employ machine learning techniques (e.g., neural network techniques, kernel-based techniques, or other machine learning techniques) for various functions in wireless communications. For example, wireless devices may employ neural network techniques for compressing a channel at a UE, decompressing a channel at a base station, or both. Such approaches may offer increased performance, including better channel predictions in higher-Doppler conditions, reduced overhead, or both.

Wireless devices may further employ machine learning techniques is connection with PMI processing and transmission. For example, wireless devices may replace conventional components of PMI calculations (e.g., selection or determination of one or more bases, coefficients, or other parameters or values) with machine learning techniques (e.g., neural networks or kernel-based models). Such approaches may be employed with a base station and UE, such as base station 105-a and UE 115-a as depicted in FIG. 2. In such approaches, base station 105-a may define one or more options or parameters associated with the machine learning techniques (e.g., neurons, structures, coefficients, other machine learning parameters, or any combination thereof) that the UE 115-a is to perform and may dynamically update such options or parameters (e.g., through DCI or other control signaling). In some examples, the UE 115-a or the base station 105-a may re-encode one or more determined or selected quantities or parameters (e.g., coefficients, bases, or other parameters or values) using machine learning approaches (e.g., a neural network). Such re-encoding may involve using a fixed payload size, packing such re-encoded quantities or parameters in control information (e.g., UCI, such as UCI part 1). Further, the base station 105-a may recover or decode such quantities or parameters using machine learning approaches (e.g., neural network techniques, such as a neural network technique that may be paired with the neural network technique used to re-encode the quantities or parameters in the first place). Such an approach may reduce or avoid uplink control signaling ambiguity (e.g., UCI payload ambiguity) that may be caused by downlink control signaling updates (e.g., DCI updates). For example, if the UE 115-a does not receive a DCI, there will be no pay load ambiguity since the UCI payload size may be fixed or known. In a further example, if the base station 105-a determines that one or more elements of received PMI are “controversial,” unexpected, or fall outside one or more parameters, the base station 105-a may decode part of all of the received PMI using a neural network that was paired with the neural network used by the UE 115-a. By doing so, the wireless communications system 200 may be more robust and may reduce or avoid control signaling ambiguity.

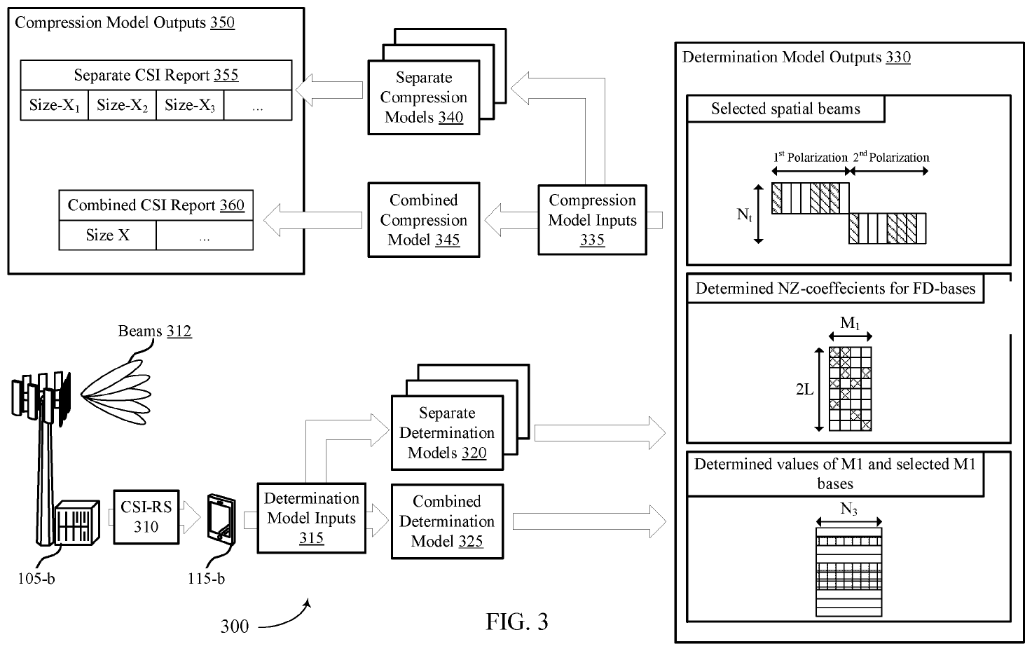

In the example depicted in FIG. 2, the UE 115-a may receive one or more control messages 220 from the base station 105-a. Control message 220 may contain an indication of a machine learning model 235. The machine learning model 235 may be configured or defined by the base station 105-a or other device for generating or compressing one or more components of a PMI (e.g., bases, coefficients, or other components of a PMI). The machine learning model 235 may include one or more various types of machine learning approaches, including one or more neural networks, one or more kernel-based models, or both. For example, the separate determination models 320, combined determination model 325, separate compression models 340, and combined compression model 345 depicted in FIG. 3 may include one or more neural networks, one or more kernel-based models, or both.

Based on the indication of the machine learning model 235 received by the UE 115-a in the control message 220, the UE 115-a may determine or compress one or more components of a PMI using the machine learning model 235 indicated in the control message 220. Further, the determination, compression, or both may be based on a characteristics of a wireless channel (e.g., as determined, identified, selected, received, or otherwise obtained based on the reference signal 225, such as a CSI-RS received from the base station 105-a). For example, the UE 115-a may determine one or more PMI components, compress one or more PMI components, or both. For example, such PMI components may be PMI components that are compressed in a frequency domain. The UE 115-a may then transmit a PMI message 230 that may include one or more PMI components that were determined or compressed (or both) in accordance with the machine learning model 235. Using the transmitted PMI, the base station 105-a may then configure one or more parameters for further wireless communications.

By employing such techniques or approaches as described herein, the wireless communications system 200, base station 105-a and UE 115-a may operate with improved robustness, increased performance, reduced overhead, or any combination thereof. Further, the use of such approaches may reduce or eliminate technical challenges present in other approaches, such as prohibitively high control information payload overhead, limited interference control, uplink control signaling ambiguity, unsuitability for high-Doppler situations, degraded performance (e.g., due to overfitting of some machine learning models), increased interference and noise, or other technical problems.

FIG. 3 illustrates an example of a PMI processing scheme 300 that supports machine learning models for precoding in accordance with examples as disclosed herein.

The PMI processing scheme 300 includes base station 105-b and UE 115-b. The base station 105-a may communicate with the UE 115-b using beams 312 (e.g., one or more such beams 312). The base station 105-b may transmit a reference signal to the UE 115-b, such as the CSI-RS 310. The CSI-RS 310 may be used by the UE 115-b to determine, identify, select, receive, or otherwise obtain one or more channel conditions, characteristics, or other channel information.

The UE 115-b may determine, identify, select, receive, or otherwise obtain determination model inputs 315. Such determination model inputs 315 may include one or more elements, characteristics, parameters, values, or other information that may be processed by a PMI component determination model, such as the separate determination models 320 or the combined determination model 325. Such determination model inputs 315 may include the CSI-RS 310, a channel measurement resource, an interference measurement resource, an indication of an estimated channel, an indication of estimated interference, one or more determined or identified PMI components (e.g., associated with one or more previous PMI reports), one or more compressed and reported PMI components (e.g., based on one or more models for compressing determined PMI components associated with one or more previous PMI reports), or any combination thereof.

The UE 115-b may then provide the such determination model inputs 315 to the separate determination models 320, the combined determination model 325, or both, depending on the situation. For example, the base station 105-b may indicate (e.g., via control signaling) to the UE 115-b which machine learning model should be used (e.g., the separate determination models 320 or the combined determination model 325). Additionally or alternatively, the UE 115-b may determine, identify, select, receive, or otherwise obtain an indication of which model to use based on one or more factors, which may include one or more aspects or characteristics of the determination model inputs 315.

The UE 115-b may use the separate determination models 320 to make separate determinations for various components of the PMI, such as the selection of spatial beams (e.g., per polarization), determination of one or more non-zero coefficients for frequency domain bases, determination of one or more quantities of frequency domain bases (e.g., M₁, M₂, or other quantities of frequency domain bases), one or more values for one or more quantities of frequency domain bases, one or more additional PMI components, or any combination thereof. For example, a separate determination model 320 may be used for each category or set of one or more components that are to be determined. Additionally or alternatively, the UE 115-b may employ the combined determination model 325 to determine one or more components of the PMI using a single machine learning model. Such components may include the selection of spatial beams (e.g., per polarization), determination of one or more non-zero coefficients for frequency domain bases, determination of one or more values for M₁, selected M₁ bases, or both, one or more additional PMI components, or any combination thereof.

Whatever machine learning model is used may produce one or more determination model outputs 330. Such one or more determination model outputs 330 may include the selection of spatial beams (e.g., per polarization), determination of one or more non-zero coefficients for frequency domain bases, determination of one or more values for M₁, selected M₁ bases, or both, one or more additional PMI components, a number of spatial domain bases, one or more indications of a selection of spatial domain bases (e.g., selected based on a determined or defined (e.g., through control signaling) number of spatial domain bases), one or more indications of types of frequency domain bases (e.g., one-dimensional DFT, two-dimensional DFT, one dimensional discrete cosine transform (DCT), two-dimensional DCT, or other types of frequency domain bases), a quantity of transfer domain bases, one or more indications of a selection of frequency domain bases (e.g., selected based on a determined or defined (e.g., through control signaling) number of bases), a number of one or more non-zero coefficients associated with one or more frequency domain bases, a location of one or more non-zero coefficients associated with one or more frequency domain bases, or any combination thereof. Such components may be used or transmitted in one or more PMI reports that the UE 115-b may transmit to the base station 105-b or other wireless device.

In some examples, the one or more determination model outputs 330 may include or be associated with one or more characteristics. Such characteristics may be defined or may be dynamically determined (e.g., through a configuration of the base station 105-b, a recommendation of the UE 115-b, or both). For example, the one or more determination model outputs 330 may be common across different ranks, layers, polarizations, or any combination thereof. Additionally or alternatively, the one or more one or more determination model outputs 330 may be different for different ranks, layers, or polarizations. Various combinations of such characteristics are possible and are contemplated by the subject matter discussed herein.

Additionally or alternatively, such components (or other PMI components not determined through the use of a machine learning model) may also be compressed by a machine learning model. For example, the PMI processing scheme 300 may also contemplate compression of one or more PMI components or other inputs. For example, the UE 115-b may provide the compression model inputs 335 to a machine learning model (e.g., the separate compression models 340, the combined compression model 345, or both) to produce the compression model outputs 350. The compression model inputs 335 may include a number of spatial domain bases, one or more indications of a selection of spatial domain bases (e.g., selected based on a determined or defined (e.g., through control signaling) number of spatial domain bases), one or more indications of types of frequency domain bases (e.g., 1D DFT, 2D-DFT, 1D discrete cosine transform (DCT), 2D-DCT, or other types of frequency domain bases), a quantity of transfer domain bases, one or more indications of a selection of frequency domain bases (e.g., selected based on a determined or defined (e.g., through control signaling) number of bases), a number of one or more non-zero coefficients associated with one or more frequency domain bases, a location of one or more non-zero coefficients associated with one or more frequency domain bases, or any combination thereof.

Such compression model inputs 335 may be provided to the separate compression models 340, the combined compression model 345, or both. A determination or selection of which machine learning models to use may be determined, identified, selected, received, or otherwise obtained based on one or more factors. For example, the base station 105-b may indicate (e.g., via control signaling) to the UE 115-b which machine learning model should be used (e.g., to the separate compression models 340, the combined compression model 345, or both). Additionally or alternatively, the UE 115-b may determine, identify, select, receive, or otherwise obtain an indication of which model to use based on one or more factors, which may include one or more aspects or characteristics of the compression model inputs 335.

Regardless of which models are used, the UE 115-b may generate one or more compression model outputs 350. Such compression model outputs 350 may include compressed versions or forms of the compression model inputs 335. Further, the compression model outputs 350 may be reported as one or more parts of a CSI report, such as the separate CSI report 355, the combined CSI report 360, or both. For example, the separate CSI report 355 may include one or more elements that may be of different sizes (e.g., size X₁, size X₂, size X₃, etc.). The combined CSI report 360 may include a single element that may be of a single size (e.g., size X). Such sizes may reflect sizes of one or more elements that were compressed using the separate compression models 340, the combined compression model 345, or both. In some examples, such sizes may be defined by the base station 105-b through control signaling, updated or modified (e.g., dynamically) by the base station 105-b through further control signaling, determined, identified, selected, received, or otherwise obtained by the UE 115-b, or any combination thereof.

In some examples, the one or more compression model outputs 350 may include or be associated with one or more characteristics. Such characteristics may be defined or may be dynamically determined (e.g., through a configuration of the base station 105-b, a recommendation of the UE 115-b, or both). For example, the one or more compression model outputs 350 may be common across different ranks, layers, polarizations, or any combination thereof. Additionally or alternatively, the one or more one or more compression model outputs 350 may be different for different ranks, layers, or polarizations. Various combinations of such characteristics are possible and are contemplated by the subject matter discussed herein.

Additionally or alternatively, an output size of the compression models (e.g., output sizes of PMI components compressed using the separate compression models 340, the combined compression model 345, or both) may be based on whether one or more parameters or characteristics are known or unknown. Such parameters or characteristics may include a number of spatial domain bases, a number of frequency domain bases, a selection of one or more spatial domain bases, a selection of one or more frequency domain bases, or any combination thereof. In some examples, such parameters or characteristics may be considered “known” if configured by the base station 105-b. Further, such parameters or characteristics may be considered “unknown” if the UE 115-b reports such parameters or characteristics to the base station 105-b. For example, if a number of spatial domain and frequency domain bases have been configured by the base station 105-b, an output size of an output from a compression model (e.g., the separate compression models 340 or the combined compression model 345) for jointly determined bases to be reported may be of a size Y, Y being a positive integer. Upon reporting of a number of spatial domain and frequency domain bases by the UE 115-b, the output size of the compression model for the jointly determined bases may become Z, where Z is a positive integer and Y is less than Z. Other combinations of dynamic adjustments are possible and are contemplated by the subject matter discussed herein.

In some examples, the UE 115-b may receive control signaling (e.g., DCI) indicating a change in one or more machine learning model parameters (e.g., neural network parameters). For example, changes may be made to one or more parameters of the separate determination models 320, combined determination model 325, separate compression models 340, combined compression model 345, or any combination thereof, such parameters may include neurons, neural network structures, neural network coefficients, one or more other parameters (e.g., for kernel-based machine learning models), or any combination thereof. In some examples, such changes may result in different determined basis types, determined basis sets, determined basis selections, spatial beam sets, spatial beam selections, or any combination thereof. In this way, the PMI processing scheme 300 may contemplate dynamic adjustments to PMI processing and transmission (e.g., based on one or more factors, such as previous PMI processing, channel conditions or characteristics, one or more indications received from one or more other devices, or any combination thereof).

The UE 115-b may apply such indicated changes or adjustments at various times. For example, if a DCI making such adjustments is a downlink grant DCI, the UE 115-b may apply the received one or more changes after sending out a positive acknowledgement (ACK) associated with a scheduled physical downlink shared channel transmission. Further, if the If the ACK is multiplexed with CSI in a same UCI, the UE 115-b may apply the one or more changes for the corresponding UCI. Additionally or alternatively, in another example where the DCI is an uplink grant DCI and the DCI schedules a physical uplink shared channel transmission on which the CSI may be multiplexed, the UE 115-b may apply the one or more changes for the corresponding CSI. Additionally or alternatively, a time or schedule for applying such changes may be defined or dynamically indicated (e.g., by the base station 105-b through control signaling). It should be noted that, due to the approaches described herein, a neural network output size may be independent from the determined PMI components, and, as such, payload size ambiguity (e.g., at the base station 105-b) may be reduced or eliminated.

Once the UE 115-b has prepared a PMI report (e.g., by determining one or more PMI components, compressing one or more PMI components, or both), the UE 115-b may transmit such a PMI report to the base station 105-b. Upon receiving the report, the base station 105-b may use machine learning based models (e.g., one or more decoders associated with one or more autoencoders that may be associated with the machine learning models used for determination or compression at the UE side) to decode one or more PMI components (e.g., PMI components determined or compressed using the separate determination models 320, the combined determination model 325, the separate compression models 340, the combined compression model 345, or any combination thereof) included in one or more subsets of a CSI report, such as the separate CSI report 355, the combined CSI report 360, or both. In some examples (e.g., to aid in base station 105-b decoding), the UE 115-b may receive one or more indications of decoder information that may be used by the base station 105-b. In this way, the UE 115-b may determine one or more models, characteristics thereof, or both, to use in the determination process, the compression process, or both.

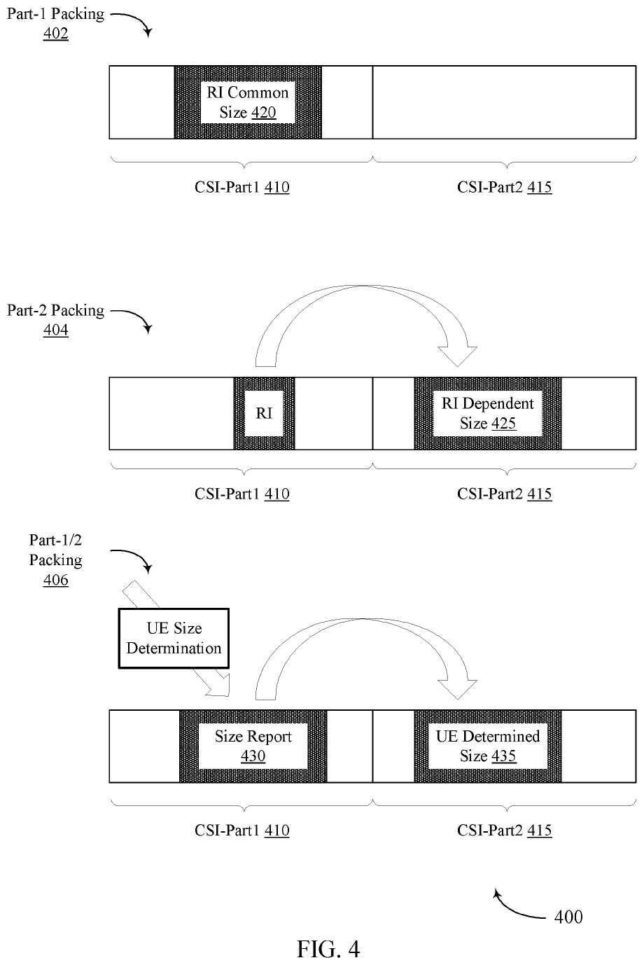

FIG. 4 illustrates an example of a PMI packing scheme 400 that supports machine learning models for precoding in accordance with examples as disclosed herein. The PMI packing scheme 400 includes various options for PMI packing, including an example of part-1 packing 402, an example of part-2 packing 404, and part-1/2 packing 406.

In the example of part-1 packing 402, a base station may define an output size of a PMI compression machine learning model, and the UE may pack, into a CSI report the output of the PMI compression machine learning model using such a defined size. For example, the UE may pack the output into the CSI-Part1 410, and the output may be of the size defined by the base station. In some examples, a common size may be used for different reported rank information (RI) (e.g., the RI common size 420) or for different quantities of the determined or compressed PMI components. For example, an output size (e.g., a number of bits) such as the RI common size 420 may remain constant regardless of the RI and a number of frequency domain compression bases that are determined. In some examples, such outputs may be packed into the CSI-Part1 410.

In the example of part-2 packing 404, a base station may define an output size of a PMI compression machine learning model, and the UE may pack, into a CSI report the output of the PMI compression machine learning model using such a defined size. For example, the UE may pack the output into the CSI-Part2 415, and the output may be of the size defined by the base station. However, such output sizes may be different for different reported RIs (e.g., the RI dependent size 425), but may be common for different quantities of the determined PMI components for the same RI. For example, given an RI of 1, an output size may be of a size (e.g., size A) regardless of a quantity of frequency domain bases that are determined. However, given an RI of 2, an output size may be of another size (e.g., size B), where size B is smaller than size A regardless of a quantity of frequency domain bases that are determined. In some examples, such outputs may be packed into the CSI-Part2 415.

In the example of part-1/2 packing 406, an output size of a PMI compression machine learning model may be determined and reported by a UE. For example, the UE may determine, identify, select, receive, or otherwise obtain (e.g., from one or more options that are defined or received (e.g., from a base station via control signaling)) a common output size (e.g., the UE determined size 435) that may be used across different RIs, and may transmit a PMI report including compressed PMI components that are of the determined, identified, selected, received, or otherwise obtained output size. Additionally or alternatively, the UE may determine, identify, select, receive, or otherwise obtain (e.g., from one or more options that are defined or received (e.g., from a base station via control signaling)) one or more output sizes (e.g., the UE determined size 435) that may be used across different RIs, and may transmit a PMI report including compressed PMI components that are of the determined, identified, selected, received, or otherwise obtained output sizes. In some examples, a size report 430 for reporting the size determination (e.g., a payload size) or selection may be defined, and may be packed into CSI-Part1 410.

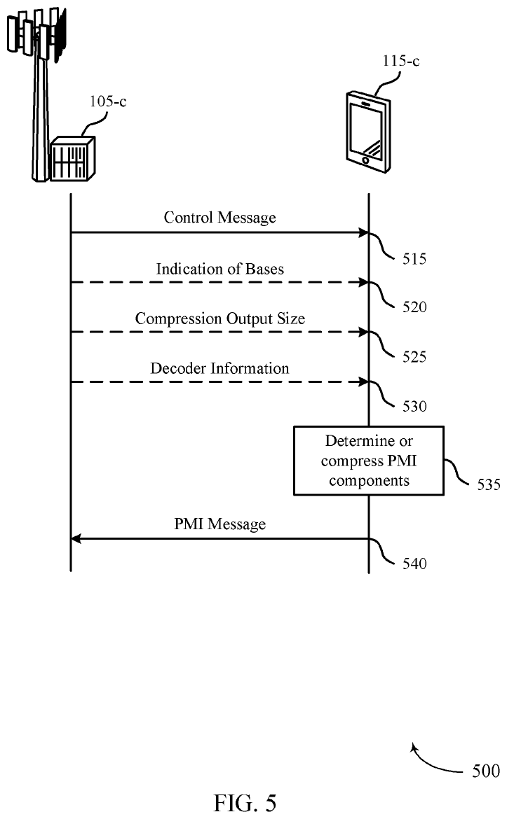

FIG. 5 illustrates an example of a process flow 500 that supports machine learning models for precoding in accordance with examples as disclosed herein. The process flow 500 may implement various aspects of the present disclosure described with reference to FIGS. 1-X. The process flow 500 may include a UE 115-c and a base station 105-c, which may be examples of UE 115 and base station 105 as described with reference to FIGS. 1-4.

In the following description of the process flow 500, the operations between the UE 115-c and the base station 105-c may be performed in different orders or at different times. Some operations may also be left out of the process flow 500, or other operations may be added. Although the UE 115-c and the base station 105-c are shown performing the operations of the process flow 500, some aspects of some operations may also be performed by the base station 105-c, the UE 115-c, one or more other wireless devices, or any combination thereof.

At 515, the UE 115-c may receive a control message from a base station indicating a machine learning model for generating or compressing one or more components of a precoding matrix indicator.

At 520, the UE 115-c may receive from the base station an indication of a numerical quantity of spatial domain bases or frequency domain bases associated with the precoding matrix indicator.

At 525, the UE 115-c may receive, from the base station, an output size of compressing the one or more components of the precoding matrix indicator.

At 530, the UE 115-c may receive from the base station an indication of decoder information associated with the base station. In some examples, determining or compressing the one or more components of the precoding matrix indicator may be further based on the decoder information associated with the base station.

At 535, the UE 115-c may determine or compress the one or more components of the precoding matrix indicator in accordance with the machine learning model and based on a characteristic of a wireless channel. In some examples, the machine learning model may include a neural network based model. In some examples, the UE 115-c may receive a downlink control information from the base station indicating a change in neural network parameters for the machine learning model. In some examples, determining or compressing the one or more components of the precoding matrix indicator is in accordance with the change in neural network parameters. In some examples, the UE 115-c may apply the change in neural network parameters according to a timing defined by one or more of: a downlink data transmission scheduled by the downlink control information, an acknowledgment of the downlink control information, an uplink control transmission scheduled by the downlink control information, a configuration message from the base station, or any combination thereof. In some examples, the machine learning model may include a kernel-based model.

In some examples, an output size of compressing the one or more components of the precoding matrix indicator may be based on a transmission rank associated with the UE, a transmission layer associated with the UE, a transmission polarization associated with the UE, or any combination thereof. In some examples, an output size of compressing the one or more components of the precoding matrix indicator may be based on the numerical quantity of spatial domain bases or frequency domain bases.

In some examples, an input to the machine learning model may include a channel state information reference signal, an indication of an estimated channel, an indication of interference on the estimated channel, one or more previously-determined precoding matrix indicator components, one or more previously-compressed precoding matrix indicator components, or any combination thereof.

In some examples, an output of the machine learning model may include an indication of a quantity of spatial domain bases, an indication of a selection of spatial domain bases, an indication of one or more frequency domain base types, a frequency domain base oversampling rate, a number of transfer domain bases, an indication of a selection of frequency domain bases, an indication of a quantity of one or more frequency domain base coefficients, an indication of one or more locations of a quantity of frequency domain base coefficients, one or more indications associated with a channel state information report, or any combination thereof.

At 540, the UE 115-c may transmit a precoding matrix indicator message including the one or more components of the precoding matrix indicator that are determined or compressed in accordance with the machine learning model. In some examples, transmitting the precoding matrix indicator message may include packing the compressed one or more components of the precoding matrix indicator into a first portion of a channel state information. In some examples, the output size may be independent of a rank indicator or a numerical quantity of the compressed one or more components of the precoding matrix indicator. In some examples, transmitting the precoding matrix indicator message may include packing the compressed one or more components of the precoding matrix indicator into a second portion of a channel state information. In some examples, the output size may be based on a rank indicator reported in a first portion of the channel state information. In some examples, transmitting the precoding matrix indicator message may include transmitting a first portion of a channel state information comprising an output size of compressing the one or more components of the precoding matrix indicator and transmitting a second portion of the channel state information comprising the compressed one or more components of the precoding matrix indicator.

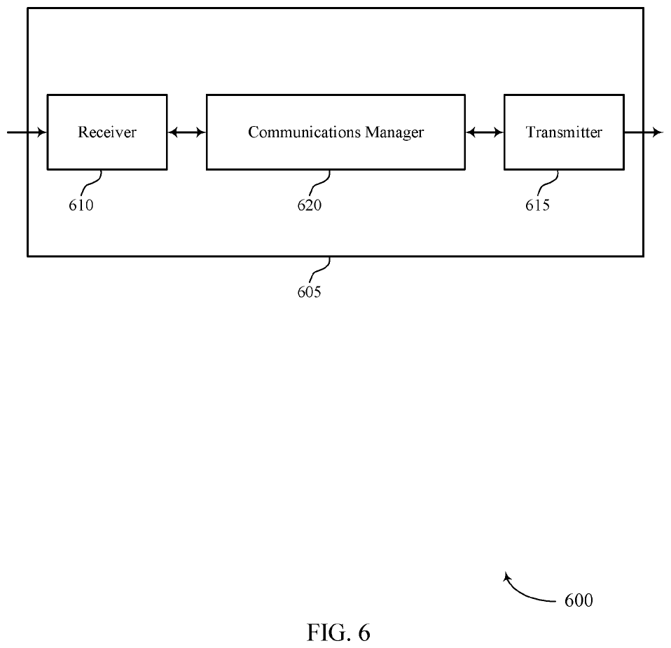

FIG. 6 shows a block diagram 600 of a device 605 that supports machine learning models for precoding in accordance with examples as disclosed herein. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to machine learning models for precoding). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to machine learning models for precoding). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of machine learning models for precoding as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

Additionally or alternatively, the communications manager 620 may support wireless communication at a UE in accordance with examples as disclosed herein. For example, the communications manager 620 may be configured as or otherwise support a means for receiving a control message from a base station indicating a machine learning model for generating or compressing one or more components of a precoding matrix indicator. The communications manager 620 may be configured as or otherwise support a means for determining or compressing the one or more components of the precoding matrix indicator in accordance with the machine learning model and based on a characteristic of a wireless channel. The communications manager 620 may be configured as or otherwise support a means for transmitting a precoding matrix indicator message including the one or more components of the precoding matrix indicator that are determined or compressed in accordance with the machine learning model.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, reduced power consumption, more efficient utilization of communication resources, or a combination thereof.

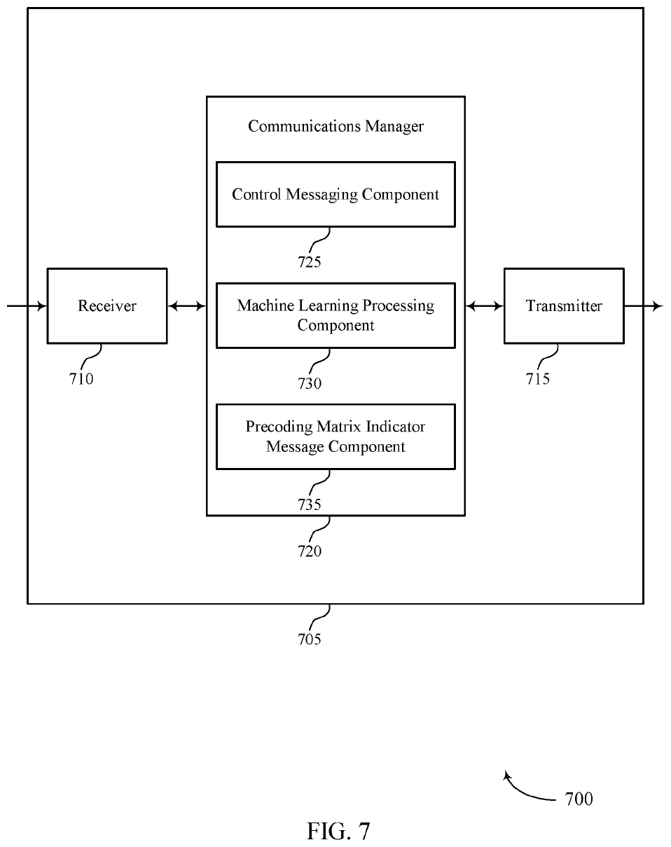

FIG. 7 shows a block diagram 700 of a device 705 that supports machine learning models for precoding in accordance with examples as disclosed herein. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to machine learning models for precoding). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to machine learning models for precoding). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of machine learning models for precoding as described herein. For example, the communications manager 720 may include a control messaging component 725, a machine learning processing component 730, a precoding matrix indicator message component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The control messaging component 725 may be configured as or otherwise support a means for receiving a control message from a base station indicating a machine learning model for generating or compressing one or more components of a precoding matrix indicator. The machine learning processing component 730 may be configured as or otherwise support a means for determining or compressing the one or more components of the precoding matrix indicator in accordance with the machine learning model and based on a characteristic of a wireless channel. The precoding matrix indicator message component 735 may be configured as or otherwise support a means for transmitting a precoding matrix indicator message including the one or more components of the precoding matrix indicator that are determined or compressed in accordance with the machine learning model.

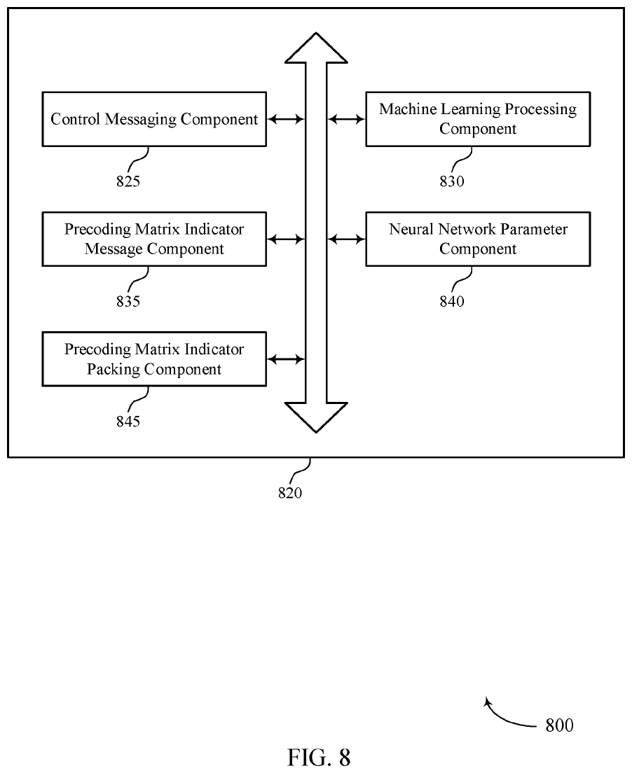

FIG. 8 shows a block diagram 800 of a communications manager 820 that supports machine learning models for precoding in accordance with examples as disclosed herein. The communications manager 820 may be an example of aspects of a communications manager 620, a communications manager 720, or both, as described herein. The communications manager 820, or various components thereof, may be an example of means for performing various aspects of machine learning models for precoding as described herein. For example, the communications manager 820 may include a control messaging component 825, a machine learning processing component 830, a precoding matrix indicator message component 835, a neural network parameter component 840, a precoding matrix indicator packing component 845, or any combination thereof. Each of these components may communicate, directly or indirectly, with one another (e.g., via one or more buses).

Additionally or alternatively, the communications manager 820 may support wireless communication at a UE in accordance with examples as disclosed herein. The control messaging component 825 may be configured as or otherwise support a means for receiving a control message from a base station indicating a machine learning model for generating or compressing one or more components of a precoding matrix indicator. The machine learning processing component 830 may be configured as or otherwise support a means for determining or compressing the one or more components of the precoding matrix indicator in accordance with the machine learning model and based on a characteristic of a wireless channel. The precoding matrix indicator message component 835 may be configured as or otherwise support a means for transmitting a precoding matrix indicator message including the one or more components of the precoding matrix indicator that are determined or compressed in accordance with the machine learning model.

In some examples, the machine learning model includes a neural network based model, and the control messaging component 825 may be configured as or otherwise support a means for receiving a downlink control information from the base station indicating a change in neural network parameters for the machine learning model, where determining or compressing the one or more components of the precoding matrix indicator is in accordance with the change in neural network parameters.

In some examples, the neural network parameter component 840 may be configured as or otherwise support a means for applying the change in neural network parameters according to a timing defined by one or more of: a downlink data transmission scheduled by the downlink control information, an acknowledgment of the downlink control information, an uplink control transmission scheduled by the downlink control information, a configuration message from the base station, or any combination thereof.

In some examples, the machine learning model includes a kernel based model.

In some examples, determining or compressing the one or more components of the precoding matrix indicator is further based on a transmission rank associated with the UE, a transmission layer associated with the UE, a transmission polarization associated with the UE, or any combination thereof.

In some examples, an output size of compressing the one or more components of the precoding matrix indicator is based on a transmission rank associated with the UE, a transmission layer associated with the UE, a transmission polarization associated with the UE, or any combination thereof.

In some examples, the machine learning processing component 830 may be configured as or otherwise support a means for receiving from the base station an indication of a numerical quantity of spatial domain bases or frequency domain bases associated with the precoding matrix indicator.

In some examples, an output size of compressing the one or more components of the precoding matrix indicator is based on the numerical quantity of spatial domain bases or frequency domain bases.

In some examples, the control messaging component 825 may be configured as or otherwise support a means for receiving, from the base station, an output size of compressing the one or more components of the precoding matrix indicator.

In some examples, transmitting the precoding matrix indicator message includes packing the compressed one or more components of the precoding matrix indicator into a first portion of a channel state information, where the output size is independent of a rank indicator or a numerical quantity of the compressed one or more components of the precoding matrix indicator.

In some examples, transmitting the precoding matrix indicator message includes packing the compressed one or more components of the precoding matrix indicator into a second portion of a channel state information, where the output size is based on a rank indicator reported in a first portion of the channel state information.

In some examples, transmitting the precoding matrix indicator message includes transmitting a first portion of a channel state information including an output size of compressing the one or more components of the precoding matrix indicator and transmitting a second portion of the channel state information including the compressed one or more components of the precoding matrix indicator.

In some examples, the control messaging component 825 may be configured as or otherwise support a means for receiving from the base station an indication of decoder information associated with the base station, where determining or compressing the one or more components of the precoding matrix indicator is further based on the decoder information associated with the base station.

In some examples, an input to the machine learning model includes a channel state information reference signal, an indication of an estimated channel, an indication of interference on the estimated channel, one or more previously-determined precoding matrix indicator components, one or more previously-compressed precoding matrix indicator components, or any combination thereof.

In some examples, the machine learning processing component 830 may be configured as or otherwise support a means for an output of the machine learning model includes an indication of a quantity of spatial domain bases, an indication of a selection of spatial domain bases, an indication of one or more frequency domain base types, a frequency domain base oversampling rate, a number of transfer domain bases, an indication of a selection of frequency domain bases, an indication of a quantity of one or more frequency domain base coefficients, an indication of one or more locations of a quantity of frequency domain base coefficients, one or more indications associated with a channel state information report, or any combination thereof.

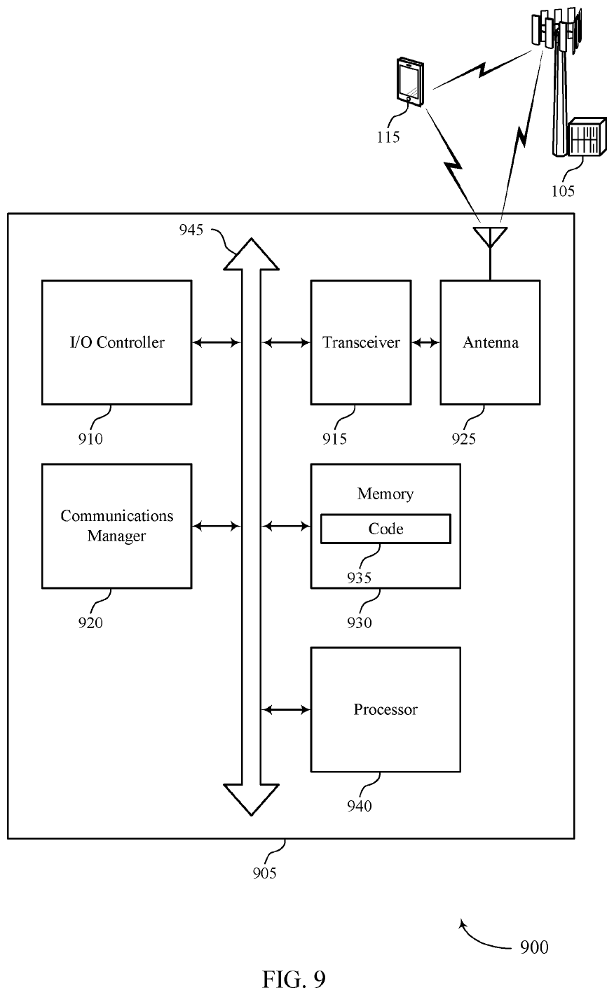

FIG. 9 shows a diagram of a system 900 including a device 905 that supports machine learning models for precoding in accordance with examples as disclosed herein. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOSR, MS-WINDOWS®, OS/2R, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting machine learning models for precoding). For example, the device 905 or a component of the device 905 may include a processor 940 and memory 930 coupled to the processor 940, the processor 940 and memory 930 configured to perform various functions described herein.

Additionally or alternatively, the communications manager 920 may support wireless communication at a UE in accordance with examples as disclosed herein. For example, the communications manager 920 may be configured as or otherwise support a means for receiving a control message from a base station indicating a machine learning model for generating or compressing one or more components of a precoding matrix indicator. The communications manager 920 may be configured as or otherwise support a means for determining or compressing the one or more components of the precoding matrix indicator in accordance with the machine learning model and based on a characteristic of a wireless channel. The communications manager 920 may be configured as or otherwise support a means for transmitting a precoding matrix indicator message including the one or more components of the precoding matrix indicator that are determined or compressed in accordance with the machine learning model.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, or a combination thereof.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of machine learning models for precoding as described herein, or the processor 940 and the memory 930 may be otherwise configured to perform or support such operations.

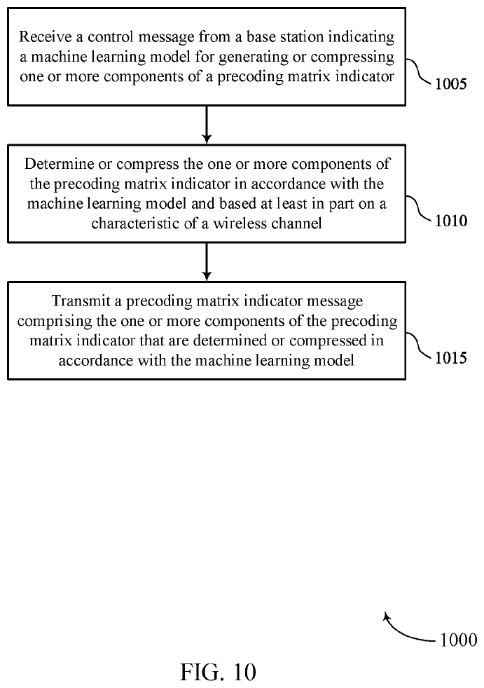

FIG. 10 shows a flowchart illustrating a method 1000 that supports machine learning models for precoding in accordance with examples as disclosed herein. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1005, the method may include receiving a control message from a base station indicating a machine learning model for generating or compressing one or more components of a precoding matrix indicator. The operations of 1005 may be performed in accordance with examples as disclosed herein. In some examples, aspects of the operations of 1005 may be performed by a control messaging component 825 as described with reference to FIG. 8.

At 1010, the method may include determining or compressing the one or more components of the precoding matrix indicator in accordance with the machine learning model and based on a characteristic of a wireless channel. The operations of 1010 may be performed in accordance with examples as disclosed herein. In some examples, aspects of the operations of 1010 may be performed by a machine learning processing component 830 as described with reference to FIG. 8.

At 1015, the method may include transmitting a precoding matrix indicator message including the one or more components of the precoding matrix indicator that are determined or compressed in accordance with the machine learning model. The operations of 1015 may be performed in accordance with examples as disclosed herein. In some examples, aspects of the operations of 1015 may be performed by a precoding matrix indicator message component 835 as described with reference to FIG. 8.

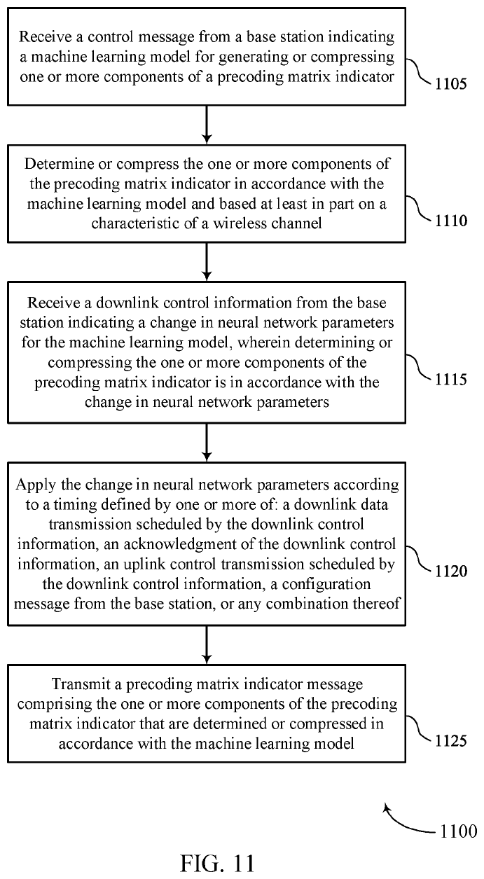

FIG. 11 shows a flowchart illustrating a method 1100 that supports machine learning models for precoding in accordance with examples as disclosed herein. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1105, the method may include receiving a control message from a base station indicating a machine learning model for generating or compressing one or more components of a precoding matrix indicator. The operations of 1105 may be performed in accordance with examples as disclosed herein. In some examples, aspects of the operations of 1105 may be performed by a control messaging component 825 as described with reference to FIG. 8.

At 1110, the method may include determining or compressing the one or more components of the precoding matrix indicator in accordance with the machine learning model and based on a characteristic of a wireless channel. The operations of 1110 may be performed in accordance with examples as disclosed herein. In some examples, aspects of the operations of 1110 may be performed by a machine learning processing component 830 as described with reference to FIG. 8.

At 1115, the method may include receiving a downlink control information from the base station indicating a change in neural network parameters for the machine learning model, where determining or compressing the one or more components of the precoding matrix indicator is in accordance with the change in neural network parameters. The operations of 1115 may be performed in accordance with examples as disclosed herein. In some examples, aspects of the operations of 1115 may be performed by a control messaging component 825 as described with reference to FIG. 8.

At 1120, the method may include applying the change in neural network parameters according to a timing defined by one or more of: a downlink data transmission scheduled by the downlink control information, an acknowledgment of the downlink control information, an uplink control transmission scheduled by the downlink control information, a configuration message from the base station, or any combination thereof. The operations of 1120 may be performed in accordance with examples as disclosed herein. In some examples, aspects of the operations of 1120 may be performed by a neural network parameter component 840 as described with reference to FIG. 8.

At 1125, the method may include transmitting a precoding matrix indicator message including the one or more components of the precoding matrix indicator that are determined or compressed in accordance with the machine learning model. The operations of 1125 may be performed in accordance with examples as disclosed herein. In some examples, aspects of the operations of 1125 may be performed by a precoding matrix indicator message component 835 as described with reference to FIG. 8.

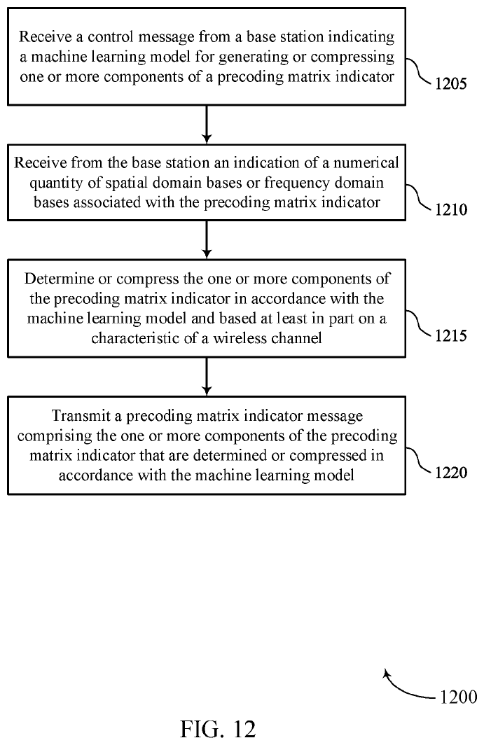

FIG. 12 shows a flowchart illustrating a method 1200 that supports machine learning models for precoding in accordance with examples as disclosed herein. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1205, the method may include receiving a control message from a base station indicating a machine learning model for generating or compressing one or more components of a precoding matrix indicator. The operations of 1205 may be performed in accordance with examples as disclosed herein. In some examples, aspects of the operations of 1205 may be performed by a control messaging component 825 as described with reference to FIG. 8.

At 1210, the method may include receiving from the base station an indication of a numerical quantity of spatial domain bases or frequency domain bases associated with the precoding matrix indicator. The operations of 1210 may be performed in accordance with examples as disclosed herein. In some examples, aspects of the operations of 1210 may be performed by a machine learning processing component 830 as described with reference to FIG. 8.

At 1215, the method may include determining or compressing the one or more components of the precoding matrix indicator in accordance with the machine learning model and based on a characteristic of a wireless channel. The operations of 1215 may be performed in accordance with examples as disclosed herein. In some examples, aspects of the operations of 1215 may be performed by a machine learning processing component 830 as described with reference to FIG. 8.

At 1220, the method may include transmitting a precoding matrix indicator message including the one or more components of the precoding matrix indicator that are determined or compressed in accordance with the machine learning model. The operations of 1220 may be performed in accordance with examples as disclosed herein. In some examples, aspects of the operations of 1220 may be performed by a precoding matrix indicator message component 835 as described with reference to FIG. 8.

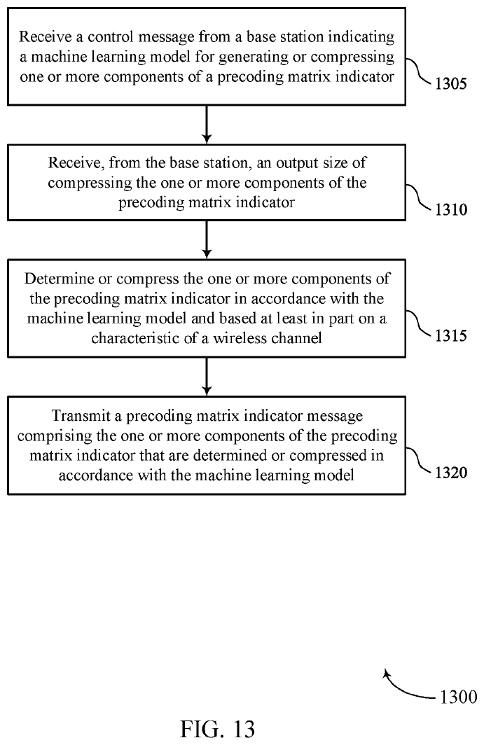

FIG. 13 shows a flowchart illustrating a method 1300 that supports machine learning models for precoding in accordance with examples as disclosed herein. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1305, the method may include receiving a control message from a base station indicating a machine learning model for generating or compressing one or more components of a precoding matrix indicator. The operations of 1305 may be performed in accordance with examples as disclosed herein. In some examples, aspects of the operations of 1305 may be performed by a control messaging component 825 as described with reference to FIG. 8.

At 1310, the method may include receiving, from the base station, an output size of compressing the one or more components of the precoding matrix indicator. The operations of 1310 may be performed in accordance with examples as disclosed herein. In some examples, aspects of the operations of 1310 may be performed by a control messaging component 825 as described with reference to FIG. 8.

At 1315, the method may include determining or compressing the one or more components of the precoding matrix indicator in accordance with the machine learning model and based on a characteristic of a wireless channel. The operations of 1315 may be performed in accordance with examples as disclosed herein. In some examples, aspects of the operations of 1315 may be performed by a machine learning processing component 830 as described with reference to FIG. 8.

At 1320, the method may include transmitting a precoding matrix indicator message including the one or more components of the precoding matrix indicator that are determined or compressed in accordance with the machine learning model. The operations of 1320 may be performed in accordance with examples as disclosed herein. In some examples, aspects of the operations of 1320 may be performed by a precoding matrix indicator message component 835 as described with reference to FIG. 8.

The following provides an overview of aspects of the present disclosure:

Aspect 1: A method for wireless communication at a UE, comprising: receiving a control message from a base station indicating a machine learning model for generating or compressing one or more components of a precoding matrix indicator; determining or compressing the one or more components of the precoding matrix indicator in accordance with the machine learning model and based at least in part on a characteristic of a wireless channel; and transmitting a precoding matrix indicator message comprising the one or more components of the precoding matrix indicator that are determined or compressed in accordance with the machine learning model.

Aspect 2: The method of aspect 1, wherein the machine learning model comprises a neural network based model, the method further comprising: receiving a downlink control information from the base station indicating a change in neural network parameters for the machine learning model, wherein determining or compressing the one or more components of the precoding matrix indicator is in accordance with the change in neural network parameters.

Aspect 3: The method of aspect 2, further comprising: applying the change in neural network parameters according to a timing defined by one or more of: a downlink data transmission scheduled by the downlink control information, an acknowledgment of the downlink control information, an uplink control transmission scheduled by the downlink control information, a configuration message from the base station, or any combination thereof.

Aspect 4: The method of any of aspects 1 through 3, wherein the machine learning model comprises a kernel based model.

Aspect 5: The method of any of aspects 1 through 4, wherein determining or compressing the one or more components of the precoding matrix indicator is further based at least in part on a transmission rank associated with the UE, a transmission layer associated with the UE, a transmission polarization associated with the UE, or any combination thereof.

Aspect 6: The method of any of aspects 1 through 5, wherein an output size of compressing the one or more components of the precoding matrix indicator is based at least in part on a transmission rank associated with the UE, a transmission layer associated with the UE, a transmission polarization associated with the UE, or any combination thereof.

Aspect 7: The method of any of aspects 1 through 6, further comprising: receiving from the base station an indication of a numerical quantity of spatial domain bases or frequency domain bases associated with the precoding matrix indicator.

Aspect 8: The method of aspect 7, wherein an output size of compressing the one or more components of the precoding matrix indicator is based at least in part on the numerical quantity of spatial domain bases or frequency domain bases.

Aspect 9: The method of any of aspects 1 through 8, further comprising: receiving, from the base station, an output size of compressing the one or more components of the precoding matrix indicator.

Aspect 10: The method of aspect 9, wherein transmitting the precoding matrix indicator message comprises packing the compressed one or more components of the precoding matrix indicator into a first portion of a channel state information, wherein the output size is independent of a rank indicator or a numerical quantity of the compressed one or more components of the precoding matrix indicator.

Aspect 11: The method of any of aspects 9 through 10, wherein transmitting the precoding matrix indicator message comprises packing the compressed one or more components of the precoding matrix indicator into a second portion of a channel state information, wherein the output size is based at least in part on a rank indicator reported in a first portion of the channel state information.

Aspect 12: The method of any of aspects 1 through 11, further comprising: transmitting the precoding matrix indicator message comprises transmitting a first portion of a channel state information comprising an output size of compressing the one or more components of the precoding matrix indicator and transmitting a second portion of the channel state information comprising the compressed one or more components of the precoding matrix indicator.

Aspect 13: The method of any of aspects 1 through 12, further comprising: receiving from the base station an indication of decoder information associated with the base station, wherein determining or compressing the one or more components of the precoding matrix indicator is further based at least in part on the decoder information associated with the base station.

Aspect 14: The method of any of aspects 1 through 13, wherein an input to the machine learning model comprises a channel state information reference signal, an indication of an estimated channel, an indication of interference on the estimated channel, one or more previously-determined precoding matrix indicator components, one or more previously-compressed precoding matrix indicator components, or any combination thereof.

Aspect 15: The method of any of aspects 1 through 14, further comprising: an output of the machine learning model comprises an indication of a quantity of spatial domain bases, an indication of a selection of spatial domain bases, an indication of one or more frequency domain base types, a frequency domain base oversampling rate, a number of transfer domain bases, an indication of a selection of frequency domain bases, an indication of a quantity of one or more frequency domain base coefficients, an indication of one or more locations of a quantity of frequency domain base coefficients, one or more indications associated with a channel state information report, or any combination thereof.

Aspect 16: An apparatus for wireless communication at a UE, comprising a processor: memory coupled with the processor; and instructions stored in the memory and executable by the processor to cause the apparatus to perform a method of any of aspects 1 through 15.

Aspect 17: An apparatus for wireless communication at a UE, comprising at least one means for performing a method of any of aspects 1 through 15.

Aspect 18: A non-transitory computer-readable medium storing code for wireless communication at a UE, the code comprising instructions executable by a processor to perform a method of any of aspects 1 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive a control message from a base station indicating a machine learning model for generating or compressing one or more components of a precoding matrix indicator;
determine or compress the one or more components of the precoding matrix indicator in accordance with the machine learning model and based at least in part on a characteristic of a wireless channel; and
transmit a precoding matrix indicator message comprising the one or more components of the precoding matrix indicator that are determined or compressed in accordance with the machine learning model.

2. The apparatus of claim 1, wherein the machine learning model comprises a neural network based model, and the instructions are further executable by the processor to cause the apparatus to:
receive a downlink control information from the base station indicating a change in neural network parameters for the machine learning model, wherein determining or compressing the one or more components of the precoding matrix indicator is in accordance with the change in neural network parameters.

3. The apparatus of claim 2, wherein the instructions are further executable by the processor to cause the apparatus to:
apply the change in neural network parameters according to a timing defined by one or more of: a downlink data transmission scheduled by the downlink control information, an acknowledgment of the downlink control information, an uplink control transmission scheduled by the downlink control information, a configuration message from the base station, or any combination thereof.

4. The apparatus of claim 1, wherein the machine learning model comprises a kernel based model.

5. The apparatus of claim 1, wherein determining or compressing the one or more components of the precoding matrix indicator is further based at least in part on a transmission rank associated with the UE, a transmission layer associated with the UE, a transmission polarization associated with the UE, or any combination thereof.

6. The apparatus of claim 1, wherein an output size of compressing the one or more components of the precoding matrix indicator is based at least in part on a transmission rank associated with the UE, a transmission layer associated with the UE, a transmission polarization associated with the UE, or any combination thereof.

7. The apparatus of claim 1, wherein the instructions are further executable by the processor to cause the apparatus to:
receive from the base station an indication of a numerical quantity of spatial domain bases or frequency domain bases associated with the precoding matrix indicator.

8. The apparatus of claim 7, wherein an output size of compressing the one or more components of the precoding matrix indicator is based at least in part on the numerical quantity of spatial domain bases or frequency domain bases.

9. The apparatus of claim 1, wherein the instructions are further executable by the processor to cause the apparatus to:
receive, from the base station, an output size of compressing the one or more components of the precoding matrix indicator.

10. The apparatus of claim 9, wherein:
transmitting the precoding matrix indicator message comprises packing the compressed one or more components of the precoding matrix indicator into a first portion of a channel state information, wherein the output size is independent of a rank indicator or a numerical quantity of the compressed one or more components of the precoding matrix indicator.

11. The apparatus of claim 9, wherein:
transmitting the precoding matrix indicator message comprises packing the compressed one or more components of the precoding matrix indicator into a second portion of a channel state information, wherein the output size is based at least in part on a rank indicator reported in a first portion of the channel state information.

12. The apparatus of claim 1, wherein transmitting the precoding matrix indicator message comprises transmitting a first portion of a channel state information comprising an output size of compressing the one or more components of the precoding matrix indicator and transmitting a second portion of the channel state information comprising the compressed one or more components of the precoding matrix indicator.

13. The apparatus of claim 1, wherein the instructions are further executable by the processor to cause the apparatus to:
receive from the base station an indication of decoder information associated with the base station, wherein determining or compressing the one or more components of the precoding matrix indicator is further based at least in part on the decoder information associated with the base station.

14. The apparatus of claim 1, wherein an input to the machine learning model comprises a channel state information reference signal, an indication of an estimated channel, an indication of interference on the estimated channel, one or more previously-determined precoding matrix indicator components, one or more previously-compressed precoding matrix indicator components, or any combination thereof.

15. The apparatus of claim 1, wherein:
an output of the machine learning model comprises an indication of a quantity of spatial domain bases, an indication of a selection of spatial domain bases, an indication of one or more frequency domain base types, a frequency domain base oversampling rate, a number of transfer domain bases, an indication of a selection of frequency domain bases, an indication of a quantity of one or more frequency domain base coefficients, an indication of one or more locations of a quantity of frequency domain base coefficients, one or more indications associated with a channel state information report, or any combination thereof.

16. A method for wireless communication at a user equipment (UE), comprising:
receiving a control message from a base station indicating a machine learning model for generating or compressing one or more components of a precoding matrix indicator;
determining or compressing the one or more components of the precoding matrix indicator in accordance with the machine learning model and based at least in part on a characteristic of a wireless channel; and
transmitting a precoding matrix indicator message comprising the one or more components of the precoding matrix indicator that are determined or compressed in accordance with the machine learning model.

17. The method of claim 16, wherein the machine learning model comprises a neural network based model, the method further comprising:
receiving a downlink control information from the base station indicating a change in neural network parameters for the machine learning model, wherein determining or compressing the one or more components of the precoding matrix indicator is in accordance with the change in neural network parameters.

18. The method of claim 17, further comprising:
applying the change in neural network parameters according to a timing defined by one or more of: a downlink data transmission scheduled by the downlink control information, an acknowledgment of the downlink control information, an uplink control transmission scheduled by the downlink control information, a configuration message from the base station, or any combination thereof.

19. The method of claim 16, wherein the machine learning model comprises a kernel based model.

20. The method of claim 16, wherein determining or compressing the one or more components of the precoding matrix indicator is further based at least in part on a transmission rank associated with the UE, a transmission layer associated with the UE, a transmission polarization associated with the UE, or any combination thereof.

21. The method of claim 16, wherein an output size of compressing the one or more components of the precoding matrix indicator is based at least in part on a transmission rank associated with the UE, a transmission layer associated with the UE, a transmission polarization associated with the UE, or any combination thereof.

22. The method of claim 16, further comprising:
receiving from the base station an indication of a numerical quantity of spatial domain bases or frequency domain bases associated with the precoding matrix indicator.

23. The method of claim 22, wherein an output size of compressing the one or more components of the precoding matrix indicator is based at least in part on the numerical quantity of spatial domain bases or frequency domain bases.

24. The method of claim 16, further comprising:
receiving, from the base station, an output size of compressing the one or more components of the precoding matrix indicator.

25. The method of claim 24, wherein transmitting the precoding matrix indicator message comprises packing the compressed one or more components of the precoding matrix indicator into a first portion of a channel state information, wherein the output size is independent of a rank indicator or a numerical quantity of the compressed one or more components of the precoding matrix indicator.

26. The method of claim 24, wherein transmitting the precoding matrix indicator message comprises packing the compressed one or more components of the precoding matrix indicator into a second portion of a channel state information, wherein the output size is based at least in part on a rank indicator reported in a first portion of the channel state information.

27. The method of claim 16, wherein transmitting the precoding matrix indicator message comprises transmitting a first portion of a channel state information comprising an output size of compressing the one or more components of the precoding matrix indicator and transmitting a second portion of the channel state information comprising the compressed one or more components of the precoding matrix indicator.

28. The method of claim 16, further comprising:
an output of the machine learning model comprises an indication of a quantity of spatial domain bases, an indication of a selection of spatial domain bases, an indication of one or more frequency domain base types, a frequency domain base oversampling rate, a number of transfer domain bases, an indication of a selection of frequency domain bases, an indication of a quantity of one or more frequency domain base coefficients, an indication of one or more locations of a quantity of frequency domain base coefficients, one or more indications associated with a channel state information report, or any combination thereof.

29. An apparatus for wireless communication at a user equipment (UE), comprising:
means for receiving a control message from a base station indicating a machine learning model for generating or compressing one or more components of a precoding matrix indicator;
means for determining or compressing the one or more components of the precoding matrix indicator in accordance with the machine learning model and based at least in part on a characteristic of a wireless channel; and
means for transmitting a precoding matrix indicator message comprising the one or more components of the precoding matrix indicator that are determined or compressed in accordance with the machine learning model.

30. A non-transitory computer-readable medium storing code for wireless communication at a user equipment (UE), the code comprising instructions executable by a processor to:
receive a control message from a base station indicating a machine learning model for generating or compressing one or more components of a precoding matrix indicator;
determine or compress the one or more components of the precoding matrix indicator in accordance with the machine learning model and based at least in part on a characteristic of a wireless channel; and
transmit a precoding matrix indicator message comprising the one or more components of the precoding matrix indicator that are determined or compressed in accordance with the machine learning model.
